(19) United States
(12) Patent Application Publication
(10) Pub. No.: US 2011/0099071 A1
(43) Pub. Date: Apr. 28, 2011

(54) Real Time Content Editing and Filtering

(76) Inventor: Moses Johnson, Philadelphia, PA (US)

(21) Appl. No.: 12/912,290

(22) Filed: Oct. 26, 2010

Related U.S. Application Data
(60) Provisional application No. 61/254,999, filed on Oct. 26, 2009.

(51) Int. Cl. G06F 17/30; G06Q 30/00

(52) U.S. Cl. 705/14.64; 707/687; 705/14.4; 707/E17.008; 707/E17.006

(57) ABSTRACT

A digital magazine publishing system is presented. A magazine publishing system can include one or more publishing development environments where different digital magazine publishers can create, manage, or distribute their digital magazines to their subscribers. Issues of the magazines can be stored on a magazine server. A subscriber can submit a request to the server for a magazine issue from the subscriber's cell phone, where the request includes device attributes related to the subscriber's phone. In response, the magazine server can obtain the requested issue and edit the issue based on the device attributes in preparation for presentation on the cell phone.

This application claims the benefit of priority to U.S. provisional application having Ser. No. 61/254,999, filed Oct. 26, 2009. This and all other extrinsic materials discussed herein are incorporated by reference in their entirety. Where a definition or use of a term in an incorporated reference is inconsistent or contrary to the definition of that term provided herein, the definition of that term provided herein applies and the definition of that term in the reference does not apply.

### FIELD OF THE INVENTION

The field of the invention is digital publishing technologies.

### BACKGROUND

Publishers of digital content for cell phones, or other mobile devices, have a great deal of difficulty publishing content for many reasons. One issue with publishing digital content is the content must be formatted to target many different makes or models of cell phones. Unfortunately, the publishers are forced into a position to make many different instances or copies of the content, which results in content management or distribution problems. A better approach would include providing access to a generic version of content that can be edited, possibly in real-time or on-the-fly, to conform to a device format that can be rendered by the mobile device. Such an approach allows for publishing content tailored in real-time to a requesting device or user.

Others have put forth effort toward providing published content to mobile devices. For example, U.S. Pat. No. 7,668,962 to Miner et al. titled “News Architecture for iTV”, filed Apr. 8, 2003, describes providing syndicated content in the form of television to various devices including telephones. U.S. patent application publication 2010/0094878 to Soroca et al. titled “Contextual Targeting of Content Using a Monetization Platform”, filed Aug. 7, 2009, discusses monetizing content distribution by associating sponsored content with contextual information supplied to a cell phone.

Unless the context dictates the contrary, all ranges set forth herein should be interpreted as being inclusive of their endpoints, and open-ended ranges should be interpreted to include commercially practical values. Similarly, all lists of values should be considered as inclusive of intermediate values unless the context indicates the contrary.

Although the above references provide support for supplying content or advertisements to mobile devices per se, the references fail to appreciate that content publishers require a platform for generating, managing, and distributing published content for mobile subscribers, especially content constructed as a digital magazine. Publishers of digital magazines also require facilities to develop an issue, release an issue, or manage back issues of their digital magazines.

Thus, there is still a need for a digital magazine publishing system.

### SUMMARY OF THE INVENTION

The inventive subject matter provides apparatus, systems and methods in which one can provide a platform where multiple digital magazine publishers can create, manage, or distribute their published content to subscribers. Contemplated magazine publishing systems include a content database configured to store magazine content for one or more magazines owned or operated by different publishers. One should appreciate that the content database can be considered to form data silos for each publisher; the silos segregate publishers from each other as desired. The content database can store issues of the magazines in a generic format that is device agnostic.

The contemplated systems can further include one or more developer interfaces, through which a publisher, or other authorized entity, can construct, manage, release, or distribute issues of their magazines. When a publisher has completed an issue, the publisher can submit the issue to the content database as a published document. In some embodiments, the developer interfaces provides access to one or more magazine templates that a publisher can use to create issues of their magazines. The templates can be stored in a template database available to the publishers.

A magazine server within the publishing system can be configured to respond to remote requests for magazine issues. For example, a cell phone can send an issue request to the server where the request includes information relating to the requested issue or attributes describe the cell phone. The magazine server can query the content database for a released issue of the magazine matching the device's request. In addition, the server can edit the content, possibly real time, to conform the issue to a device format consumable by the requesting device. Editing of a magazine issue can be handled by an editing facility having one or more device filters targeting different devices or platforms. The server can select a proper device filter based on attributes provide in the issue request.

As used herein, the term “magazine” is intended to convey an owned publication released periodically to subscribers in the form of issues. One should not confuse an issue of a magazine with the magazine itself. A magazine is considered to include all issues and an issue is a single published instance of the magazine. A digital magazine is considered to include an a priori defined arrangement of digital data (e.g., text, image, video, audio, etc.) released as issues, each issue having a defined core content presentation.

Various objects, features, aspects and advantages of the inventive subject matter will become more apparent from the following detailed description of preferred embodiments, along with the accompanying drawing figures in which like numerals represent like components.

### BRIEF DESCRIPTION OF THE DRAWING

FIG. 1 is a schematic of a publishing system.

FIG. 2 is a diagram of a magazine publishing system content database where magazines are segregated from each other.

### DETAILED DESCRIPTION

It should be noted that while the following description is drawn to a computer/server-based digital content publishing system, various alternative configurations are also deemed suitable and may employ various computing devices including servers, interfaces, systems, databases, engines, controllers, adapters, or other types of computing devices operating individually or collectively. One should appreciate the computing devices comprise a processor configured to execute software instructions stored on a tangible, non-transitory computer readable storage medium (e.g., hard drive, solid state drive, RAM, flash, ROM, etc.). The software instructions preferably configure the computing device to provide the roles, responsibilities, or other functionality as discussed below with respect to the disclose apparatus. In especially preferred embodiments, the various servers, systems, databases, or interfaces exchange data using standardized protocols or algorithms, possibly based on HTTP, HTTPS, AES, public-private key exchanges, web service APIs, known financial transaction protocols, or other electronic information exchanging methods. Data exchanges preferably are conducted over a packet-switched network, the Internet, LAN, WAN, VPN, or other type of packet switched network.

One should appreciate that the disclosed techniques provide many advantageous technical effects including managing versions of multiple digital publications, where the digital publications can be owned by different entities. Issues of a digital publication can be formatted on-the-fly to conform to a device format used by a subscriber.

As used herein, and unless the context dictates otherwise, the term “coupled to” is intended to include both direct coupling (in which two elements that are coupled to each other contact each other) and indirect coupling (in which at least one additional element is located between the two elements). Therefore, the terms “coupled to” and “coupled with” are used synonymously.

The following discussion is provided within the context of publishing one or more digital magazines targeting cell phones. The astute reader will appreciate that the disclosed techniques can be readily extended and applied to publishing other forms of content including audio content (e.g., songs, radio stations, news, etc.), video content (e.g., TV channels, movies, on-line videos, etc.), games (e.g., interactive fiction, MMORPGs, etc.), or other forms of digital content.

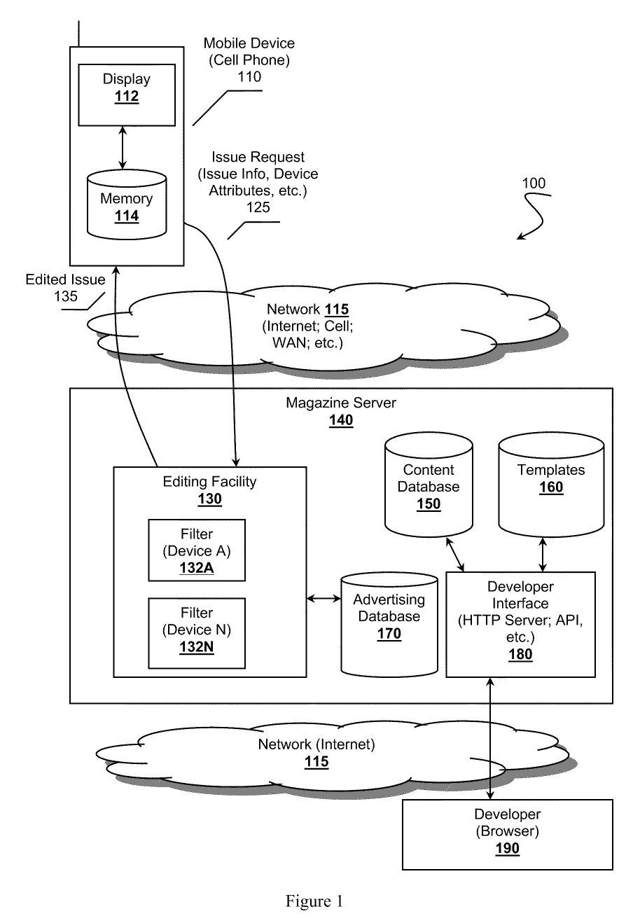

In FIG. 1, magazine publishing system 100 includes magazine server 140, content database 150, and developer interface 180. Magazine server 140 provides a platform from which one or more of developer 190 can create or publish issues of their magazine targeting many different heterogeneous types of mobile devices 110 (e.g., cell phone, game consoles, etc.). Although magazine server 140 is illustrated as a single server housing various elements, one should appreciate that the individual elements can be distributed over network 115 as desired.

Magazine server 140 can provide a developer interface 180 through which a remote developer 190 can access the services provided by the magazine server 140 over network 115. Developer interface 180 can include a web server hosting web pages, active pages, FLASH™, APIs, or other types of interfaces. Preferably, developer interface 180 configures a remote browser to render one or more user interfaces for developer 190. In some embodiments, the developer user interface includes an Integrated Development Environment (IDE) or other types of development tools. Contemplated development tools can include version control systems (e.g., CVS, Subversion, etc.), back-up utility to archive work, editors (e.g., graphics, documents, layout, design, etc.), or other types of development tools that can aid in creating one or more issues of a magazine. For example, developer 190 can use the IDE or developer tools to create an issue of a magazine as a project within the IDE. The developer could establish an issue of the magazine based on an a priori defined, possibly commonly available, template 160 stored on magazine server 140. The IDE could allow developer 190 to upload content to content database 150, manage content files, manage versions of a magazine issue, compile a magazine, archive issues of the magazine, or publish an issue of the magazine. When desired, the digital content of the management can be committed for distribution as publishable content, preferably in a generic format with respect to mobile devices.

Magazine server 140 can also include advertising database 170, which can store promotional content from one or more advertisers. The promotional content can be integrated with a published issue of a magazine when the issue is request from a mobile device 110.

In some embodiments, templates 160 can include reserved locations within an issue format for advertisements. Promotional content from advertisements database 170 can be integrated into a published issue at different times. For example, when developer 190 publishes or otherwise releases an issue of the magazine, magazine server 140 can integrated the promotional content at that time based on the published content, fees paid by the advertiser, subscriber base to the magazine or other information available to magazine server 140. Another example includes integrating promotional content on-the-fly as an issue is providing to mobile device 110.

Promotional content can include living content that can change at any time. In more preferred embodiments, promotional content is integrated with a released issue of the magazine based on both the content of the issue (e.g., text, audio, images, metadata, etc.) and device attributes supplied by mobile device 110.

It is contemplated that a magazine publisher will pay a fee in exchange for accessing the services provided by magazine server 140. If a sufficient fee is paid, developer 190 can be authorized to control how, when, or where promotional is to be inserted into their release issues.

One or more subscribers to a magazine can use their mobile devices 110 to request an issue of magazine over network 115. Mobile device 110 preferably includes display 112 and memory 114. When an issue of the magazine arrives, the published issue's content can be stored in memory 114 in preparation for presentation on display 112. Preferred mobile devices 110 comprise hand-held computing devices including cell phones, game players, electronic book readers, or other devices that can be carried in a user's hand. In some embodiments, mobile device 110 comprises a magazine reader application or app that configures the mobile device to obtain the magazine's published issue content and to render the content for presentation on the device visually or audibly.

Mobile device 110 can request a magazine issue by transmitting issue request 125 to magazine server 140. Issue request 125 can include one or more packets of information identifying a magazine. In addition issue request 125 can include device attributes that characterize mobile device 110, the subscriber, environment of the device, or other information. Magazine server 140 can use the device attributes and magazine identification information to properly retrieve a released issue of the specified magazine. Editing facility 130 can then prepare the issue for presentation on mobile device 110.

Device attributes can include a wide variety of information regarding mobile device 110. For example, device attributes can include direct attributes that describe the device itself. Direct attributes can include a device manufacture, a class of device, a device make, a device model, a serial number, a device property, an operating system version, or other device characteristics. Device properties can also include content rendering parameters (e.g., display size, audio capabilities, available memory, etc.) that can be utilized by editing facility 130 to determine how best to edit the released issue content to conform to a device format supported by the requesting mobile device 110. It is contemplated a serial number or model number could be sufficient for a content server to determine the capabilities of mobile device 110.

Device attributes could also include indirect attributes that describe a circumstance or environment in which mobile device 110 finds itself. For example, indirect attributes could include sensor data collected by the mobile device possibly comprising a captured image, collected sound, geo-location information (e.g., GPS coordinates, cell tower, etc.), or other ambient data. Indirect attributes could also include historical information relating to the device's usage, where the historical information could be stored on the device itself or recorded in a database accessible by magazine server 140.

Editing facility 130 can be configured to edit a released magazine issue to target mobile device 110 based on device attributes within issue request 125. Magazine server 140 can provide the device attributes to editing facility 130, which in turn uses the device attributes to select an appropriate filter 132A through 132N (“filters 132”) for mobile device 110 or to instruct a selected filter to edit the content for presentation on mobile device 110. In some embodiments, editing facility 130 can include one or more filters 132 for each class of supported devices (e.g., Nokia, LG, Motorola, Apple, Android, etc.), for each supported model of device (e.g., iPhone, Voyager, etc.), for each supported operating system (e.g., iOS, Android, etc.), for each supported type of device (e.g., cell phone, game player, book reader, etc.), or other type of attribute.

Device filters 132 can obtain the published issue content from the content database 150 and convert the published issue content from a generic intermediary format (e.g., XML, etc.) into presentable content on mobile device 110 represented by edited issue 135. Edited issue 135 is transmitted back to mobile device 110 in response to issue request 125. Filters 132 can operate in a real-time fashion to ensure that edited issue 135 is properly tailored to the specific requesting mobile device 110, possibly at the point of time when the request was made. Furthermore, the edited issue is prepared to conform to a device format that preferably matches the capabilities of the requesting mobile device 110. In some embodiments, edited issue 135 can be compressed to reduce transmission time back to mobile device 110.

Editing of an issue to create edited issue 135 can take on many different aspects. Example editing can include the following types of actions.
Converting the format of an issue from a first format, a generic intermediary format for example, that is not compatible with the requesting mobile device to a second format. For example, converting a video file from 3GP to MP4.
Removing one or more portions of content from an issue, removing hyperlinks for example, possibly because a requesting device does not support web browsing due to device restrictions or lack of an appropriate subscriber plan.
Adding one or more content additions to the issue. For example, advertising can be inserted into the edited issue, possibly based on the device attributes or according to a filter policy.
Tailoring the edited issue to a specific requesting mobile device 110 based on device attributes. For example, edited issue 135 can be tailored to a wireless carrier, to a class of device, to a specific make or model, or to a subscriber or user.
Merging one or more media streams representing the publishable content into a single stream again based on device attributes. For example, a developer-created issue having one or more content streams representing a custom TV channel or radio station representing a first media stream could be merged with a second, advertising stream.
Prioritizing distribution of the edited issue to ensure proper downloading of the content. In some embodiments, advertisements can be prioritized over the prepared core issue content. It is also contemplated that prepared issue content could be prioritized over advertisement content possibly based on a subscriber fee. In such an embodiment, the editing facility can include a distributed editing facility.
Distributing the active of filtering of the publishable content across multiple filters. In such an approach, the load on editing facility 130 can be distributed over a network 115 of devices to handle larger loads. For example, a first filter 132 could edit based on a class of device, then a second stage filter could edit the content based on a device model, and a third stage filter could edit the content based on collected ambient data to tailor the content to a specific device circumstance.

Although only few examples of editing, it should be appreciated that all forms of preparing edited issue 135 for distribution to a requesting mobile device 110 are contemplated.

One should appreciate that the disclosed techniques allows subscribers to request digital magazine issues as desired. Rather than merely pointing a web browser to a web page, the contemplated approach provides for obtaining a prepared issue of a digital magazine. The content can be downloaded upon request and edited in real-time to target the requesting device. Consider an example where a subscriber is about to board a long flight. The subscriber can request various issues of digital magazines. The magazines and their associated content can be downloaded directly to the phone in en toto where the content can be edited in real-time based on information in the request. When on board the flight where a network connection might be unavailable, the subscriber can view the content at their leisure. It is also contemplated, that an editing facility 130 could use the device attributes to determine that the subscriber is in the airport and prepare appropriate advertising. It is also contemplated that the editing facility could obtain additional information from remote sources, an airport's departure schedule for example, to edit the content and prepare advertisements that would be suited for traveler's destination.

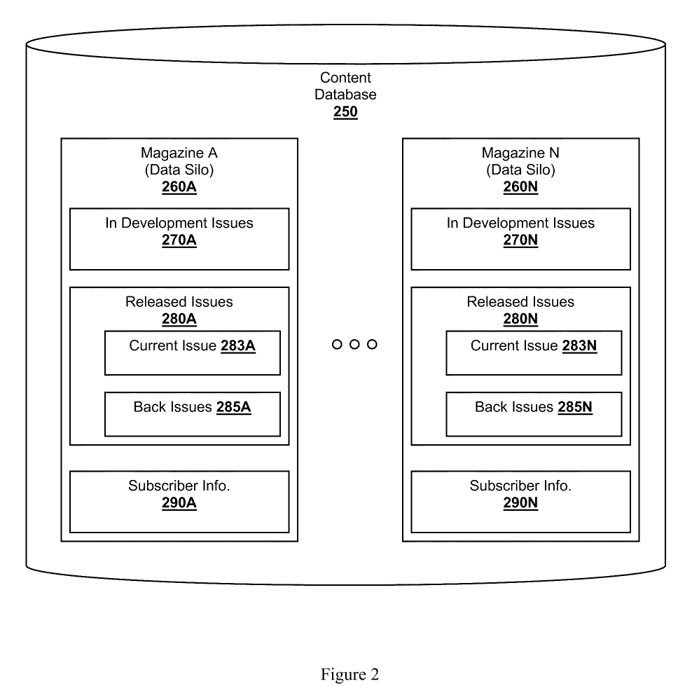

FIG. 2 presents an overview of content database 250 storing multiple magazines 260A through 260N where each magazine can be owned by different publishers. As each publisher creates issues of their magazine, content database 250 can store issues of magazines 260A through 260N in their own segregated data silos. Only authorized developers or subscribers can gain access to the issues. Issues of the magazines can be stored in the data silos preferably in a generic format, possibly based on a serialized format (e.g., XML, etc.).

As shown, issues can be organized based on their release state. For example, in development issues 270A and 270N (“in development issues 270”) represent issues of their respective magazines that are currently in development for future release, but not yet officially released. Content database 250 can restrict access to in development issues 270 to only developers. When the issues are complete, they can be classified as released issues 280A or 280N (“released issues 280”) indicating that the issues are generally available for download. Released issues 280 can be further classified into current issues 283A or 283N (“current issues 283”), or back issues 285A or 285N (“back issues 285”). Current issues 283 could demand higher price from purchases while back issues 285 might not command premium prices. Naturally, subscribers could gain access to all of released issues 280 assuming subscription fees have been paid. One should note the inventive subject matter is considered to include restricting access to issues 270, 280, 283, or 285 based on one or more of release state, user credentials, fees paid by a subscriber or publisher, device attributes, or other parameters.

Each magazine 260A through 260N data silo can also include subscriber info 290A through 290N, respectively, where the subscriber information is also segregated. Subscribe info 290 can include information about which devices or subscribers have rights to issues of magazines 260. Information can include subscriber name, account numbers, mobile device serial numbers, device make, or other information.

It should be apparent to those skilled in the art that many more modifications besides those already described are possible without departing from the inventive concepts herein. The inventive subject matter, therefore, is not to be restricted except in the scope of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refers to at least one of something selected from the group consisting of A, B, C . . . and N, the text should be interpreted as requiring only one element from the group, not A plus N, or B plus N, etc.

What is claimed is:

1. A digital magazine publishing system, comprising:
a content database storing one or more publishable magazines in a generic format;
a content developer interface configured to allow multiple publishers to edit issues of their own magazines and to store the issues within the content database; and
a magazine server configured to (a) receive a magazine issue request from a mobile device, the request comprising device attributes, (b) retrieve an issue from the content database that satisfies the magazine issue request, (c) edit the issue to conform to a device format according to the device attributes, and (d) send the edited issue back to the device over a network.

2. The system of claim 1, wherein the content server is configured to store a plurality of issues for each publishable magazine in segregated data silos.

3. The system of claim 2, wherein at least some of the issues comprise back issues.

4. The publishing system of claim 1, wherein the edited issue is filtered with respect to the published content.

5. The publishing system of claim 1, wherein the magazine server comprises a distributed editing facility.

6. The publishing system of claim 1, wherein the magazine server comprises filters that filter the edited issue based on a class of device in the attributes.

7. The publishing system of claim 6, wherein the filters operate according to a device model in the attributes.

8. The publishing system of claim 1, wherein the content server prioritizes sending portions of the edited issue to the mobile device.

9. The publishing system of claim 8, wherein the edited issue includes advertisements that are prioritized to be sent before non-advertisement content.

10. The publishing system of claim 9, wherein the content server is configured to select advertisements based on the device attributes.

11. The publishing system of claim 8, wherein the edited issue includes non-advertisements that are prioritized to be sent before advertisement content based on a fee.

12. The publishing system of claim 1, wherein the device attributes include ambient data collected by a sensor of the mobile device.

13. The publishing system of claim 12, wherein the ambient data includes geo-location information.
